(19) United States
(12) Patent Application Publication
(10) Pub. No.: US 2023/0383641 A1
(43) Pub. Date: Nov. 30, 2023

(54) COMPUTER-IMPLEMENTED METHOD FOR DETERMINING AN OPERATIONAL PROPERTY OF A DRILL-ROD BOREHOLE PUMP, AND ANALYSIS DEVICE AND PUMP SYSTEM FOR SAME

(71) Applicant: Siemens Energy Global GmbH & Co. KG, Munich, Bayern (DE)

(72) Inventors: Stefan Gschiel, Vienna (AT); Helmut Wimmer, Güssing (AT); Helmut Schnabl, Melk (AT)

(73) Assignee: Siemens Energy Global GmbH & Co. KG, Munich, Bayern (DE)

(21) Appl. No.: 18/030,856

(22) PCT Filed: Sep. 24, 2021
(86) PCT No.: PCT/EP2021/076390

§ 371 Date: Apr. 7, 2023

(30) Foreign Application Priority Data
Oct. 15, 2020 (EP) 20202028.5

(51) Int. Cl. E21B 47/009; E21B 43/12

(52) U.S. Cl. CPC E21B 47/009; E21B 43/127; E21B 2200/20

(57) ABSTRACT

A computer-implemented method for determining an operational property of a drill-rod borehole pump. A load-distance diagram with curve points for the pump is ascertained by an analysis device and provided as an operational load-distance diagram with operational curve points. In a training mode, a model load-distance diagram with respective model curve points is provided, and normalized to a specified reference variable, and for at least one sub-quantity of the model curve points, a model is generated and trained on the basis of a Kohonen network with elliptical Fourier descriptors. In an operating mode, the operational curve points are normalized to the reference variable, elliptical Fourier descriptors are determined for the operational curve points, and checked to determine a similarity between the elliptical Fourier descriptors of the operational curve points and the model of the Kohonen network, and if so, the operational property of the pump is determined.

### CROSS REFERENCE TO RELATED APPLICATIONS

This application is the US National Stage of International Application No. PCT/EP2021/076390 filed 24 Sep. 2021, and claims the benefit thereof. The International Application claims the benefit of European Application No. EP20202028 filed 15 Oct. 2020. All of the applications are incorporated by reference herein in their entirety.

### FIELD OF INVENTION

The invention relates to a computer-implemented method for determining an operational property of a drill-rod borehole pump, wherein the pump has a pump head which is connected to a kinematic converter via a drill rod, and the kinematic converter is driven by a motor during operation and a load-distance diagram with curve points for the pump is ascertained by an analysis device using an acquisition means and is provided as an operational load-distance diagram with operational curve points.

The invention also relates to a computer program, an electronically readable data carrier and a data carrier signal.

In addition, the invention relates to an analysis device having a storage device and a pump system for determining an operational property of a drill-rod borehole pump.

### BACKGROUND OF INVENTION

Borehole pumps or conveying pumps are used as conveying devices for the extraction of liquids in underground repositories if the repository pressure is not sufficient for the liquid to reach the surface independently or in sufficient quantities. Most of the time they are used to pump oil. Other areas of application are the pumping of brine and spa waters.

The image of most oil fields features drill-rod borehole pumps, which due to their appearance and their movement are also called horsehead pumps or nodding donkeys. The actual pump mechanism—a piston with check valves—is located in a separate pipe section in the drill hole near the oil-bearing layer. The piston is moved continuously up and down by means of a screw-on rod of a horsehead oil pump located on the surface. This is implemented by the so-called horsehead. It consists of one end of a circular arc segment arranged as a drilling beam, to the top of which a pair of steel ropes or chains is clamped.

The machine is usually electrically driven. However, if there are energy-containing gases sufficiently well dissolved in the oil, a portion of these gases can be separated from the conveyed material on site by means of a degasser and fed to a gas motor that drives the pump.

Depending on the pump type and size, the working stroke is 1 to 5 m. It is common to perform two-and-a-half to twelve strokes per minute. The drill-rod borehole pump can be used economically up to delivery depths of about 2500 m. Other pump systems are more suitable for greater depths due to the large weight of the fluid column to be raised.

On account of its special motion geometry, the “Mark II” pump type from the Texas manufacturer Lufkin Industries is particularly suitable for high pumping rates from large depths.

The “sucker rod” pump type has a suction rod, that is, a steel rod typically between 25 and 30 feet long with a thread at both ends, which is used in the oil industry to connect the surface and borehole components of a reciprocating pump installed in an oil well.

An extremely valuable tool for analyzing the borehole performance is a borehole test rig which measures the load on the polished rod in relation to the position of the polished rod.

Using dynamometers, the rod position and rod load can be recorded over time. The load measuring part of the dynamometer is attached to the polished rod so that the load can be detected and sent to a recorder. An accompanying part of the performance test rig mounted on the lifting beam detects the position of the polished rod and sends it to the same recorder. The generated graph is called a dynagraph, or more commonly a dynamometer or dynagraph chart, and corresponds to a load-distance diagram.

Dynamometer charts taken at the surface can rarely be used directly to record the operating conditions of the borehole pump, as they also reflect all forces (static and dynamic) occurring from the pump to the borehole head. However, if a dynamometer is located directly above the pump, the recorded chart is a true indicator of the pump operation. Gilbert's dynagraph (a mechanical dynamometer) achieved this in the 1930s. Rod loads directly above the pump, which are recorded as a function of the pump position, distinguish dynagraph charts from surface charts. Although the application of Gilbert's Dynagraph allowed direct investigation of pumping problems, the practical effects associated with the need to run the instrument in the borehole far outweighed its advantages.

Up to now, the operating conditions of a drill-rod borehole pump have been detected using sensors which record the effective forces or the current position (inclination) of the beam (or “crank arm”), for example by means of force sensors, Hall sensors or proximity sensors. The position of the rod is calculated from these. However, it is time-consuming to calibrate the various sensors relative to one another. In addition, inaccurate calibration can cause errors that can adversely affect the evaluation of measurement data.

### SUMMARY OF INVENTION

The object of the invention is to provide a method and a device for determining the operational properties of a drill-rod borehole pump, allowing the operating conditions to be determined in a simple and reliable manner and with high accuracy so that a comprehensive diagnosis of an operating state can be performed.

The object according to the invention is achieved by a method of the type described above, wherein in a training mode, at least one model load-distance diagram with respective model curve points is provided by the analysis device, said model load-distance diagram being normalized to a predefined reference variable, and for at least one subset of the model curve points, a model is generated and trained on the basis of a Kohonen network with elliptical Fourier descriptors, and in an operating mode, the operational curve points are normalized to the reference variable, elliptical Fourier descriptors are determined for the operational curve points, and a check is carried out to determine whether a similarity exists between the elliptical Fourier descriptors of the operational curve points and the model of the Kohonen network, and if so, the operational property of the pump is determined therefrom.

This means that one or more model load-distance diagrams of other pumps can be used and, for example, a newly commissioned pump can be applied immediately, i.e. without prior training with dedicated operational load-distance diagrams.

In addition, detection of features that allow an indication of an operational property of the pump can be achieved in a particularly simple manner.

After normalization, an elliptical Fourier transformation can be used.

Deviations of the operational load-distance diagram from the load-distance diagram model, that is, from the training model, can be detected, for example, as an undesirable operational property of the pump itself.

Likewise, a currently detected pumped medium which is conveyed by the pump can be detected by comparing it with a corresponding training model that describes this same medium.

Consequently, both the operation of the pump with its components and the pumped medium can be analyzed efficiently and reliably.

The pumped medium is usually a mixture of gas, sand/rock particles, water, oil and, in some cases, chemical additives.

This ensures that the operating conditions of the pump can be ascertained in a simple and reliable manner, by using machine learning to use a pump model that incorporates empirical values and forecasts from other pumps in the analysis.

This can improve the accuracy of the determination and diagnosis of an operating condition.

By normalizing the load-distance diagram model, which can be described by means of a corresponding diagram, and the operational load-distance diagram, the two-way comparison can be carried out easily and accurately.

In the normalization, a scaling or axis adjustment is carried out in the load-distance diagram, as is common practice for the person skilled in the art, so that a direct comparison of the curve shapes is possible.

The reference quantity can thus be a uniform scale range onto which the respective diagrams are mapped.

This is necessary because there are different physical differences between different pumps, such as the pump geometry, the pump depth, the pump speed, etc., which give rise to absolute differences in load and piston displacement for the different pumps but have no influence on the curve shape.

These absolute differences would affect the outcome of the neural network approach used, which would lead to a different classification of cases which based on their shape would belong to the same class.

This makes it possible to take data from other pumps and other pump types into account in the load-distance diagram model, which means that a corresponding load-distance diagram model becomes available very quickly after a new pump has been commissioned.

By forming a “sub-surface dynachart”, i.e. an operational load-distance diagram for the underground pump head, it is possible to eliminate the dependence of the pump type used, i.e. different pump design compared to that used in the method mentioned above.

This can be carried out, for example, by applying a finite element calculation and an FFT to a “surface dynachart”, i.e. an operational load-distance diagram of the entire pumping system.

As a result, a lengthy training of the load-distance diagram model on site can be reduced or even completely dispensed with.

It is advantageous if, after a similarity check using one or more Kmeans decision trees, an additional check is carried out by subsequently determining whether a curve formed by the operational curve points includes one or more reference points generated by means of machine learning. This is illustrated in more detail in the attached exemplary embodiment. This enables the operational properties to be detected in a particularly targeted manner.

In a refinement of the invention it is provided that the Kohonen network has an input layer with input variables and a second layer with neurons, and each input variable is connected to all neurons of the second layer via a respective weight function.

This ensures that features are recognized independently of each other, which increases the probability of detection when determining the operational property of the pump.

In a refinement of the invention it is provided that the neurons in the second layer are arranged as a virtual, two-dimensional grid.

The grid can preferably map the geometric position or the position of an image region in the load-distance diagram to the assigned neuron in order to produce a visual assignment of the individual neurons to positions or regions of a load-distance diagram.

This is advantageous in order to be able to determine a favorable dependence of the neurons on one another, namely in the form of a direct mapping of the neurons to positions or regions in relevant load-distance diagrams, which increases the probability of detection when determining the operational property of the pump.

In a refinement of the invention it is provided that during the training of the Kohonen network, a neuron with an input vector applied to the input variables is trained first, and then neighbors of the neuron are determined, and the corresponding weight functions for the neighbors are adjusted and the model is trained again.

This is advantageous because the neighbors of each neuron are in geometric proximity to each other in relevant load-distance diagrams, which increases the probability of detection when determining the operational property of the pump.

The determination of neighbors can be carried out in a simple way from a visual grid representation of neurons.

In a refinement of the invention it is provided that the motor is electrically operated and an acquisition means is additionally provided to detect the power consumption of the motor during its operation, from which the operational properties of the conveying pump are determined.

This means that the acquisition of the load-distance diagram can be simplified, while at the same time increasing the accuracy in determining the curve points and, by combining it with the above-mentioned analysis method, further improving the overall accuracy in the determination of the operational property.

The object according to the invention is achieved by a computer program comprising commands which, when executed by a computer, cause the computer to execute the method according to the invention.

The object according to the invention is achieved by an electronically readable data carrier with readable control information stored thereon, which comprises at least the computer program according to the invention and is designed in such a way that it carries out the method according to the invention when the data carrier is used in a computing device.

The object according to the invention is achieved by a data carrier signal which transmits the computer program according to the invention.

The object according to the invention is also achieved by an analysis device having a memory of the type mentioned above, the device being configured to analyze a supplied operational load-distance diagram with the method according to the invention, and to determine the operational property therefrom.

The analysis device has two modes of operation, namely a training mode and an operational mode.

The training mode is used to generate and train a load-distance diagram model of the pump, wherein separate load-distance diagram models can be trained for multiple operating modes of the pump in order to recognize these modes accordingly.

The training mode is run at the beginning of the pump system operation in order to make available one or more load-distance diagram models based on machine learning (ML) for the subsequent operating mode, in which the running operation of the pump system can be continuously monitored by the analysis device.

The operating mode is used to compare a currently acquired data set in the form of measuring points acquired by an acquisition means, for example with a selected load-distance diagram model, and to recognize the operating mode assigned to this model if it matches the load-distance diagram model.

In addition, a change in the detected operational property can indicate another parameter for the operational property.

For example, a sequence in the change of detected operating media can provide information as to whether there is a material inhomogeneity in the medium.

It could also be detected, for example, whether there is a break in any of the pump components if a changed movement pattern of the pump head was detected only in upward movements.

The object according to the invention is also achieved by a pump system of the type mentioned above, wherein the pump has a pump head which is connected to a kinematic converter via a drill rod, and the kinematic converter is driven by a motor during operation, and an acquisition means which is configured to acquire and provide a load-distance diagram of the pump with curve points, as well as the analysis device according to the invention with a memory configured to ascertain the operational property from the provided load-distance diagram.

### BRIEF DESCRIPTION OF THE DRAWINGS

The invention is explained hereafter in more detail by means of an exemplary embodiment shown in the enclosed drawings. In the drawings

FIG. 1 shows an exemplary embodiment of a system according to the invention with a drill-rod borehole pump,

FIG. 2 shows an exemplary embodiment of a pump head of a drill-rod borehole pump,

FIG. 3 shows an exemplary embodiment of a flow diagram of a method for determining a load-distance diagram from the power consumption of an electrically operated pump motor,

FIG. 4 shows a first exemplary embodiment of a load-distance diagram,

FIG. 5 shows load-distance diagrams for a pump for different power levels,

FIG. 6 shows load-distance diagrams for a pump for different loads and operating modes,

FIG. 7 shows a temporal graph of a current curve of an electric drive motor for a drill-rod borehole pump,

FIG. 8-12 show examples of operational load-distance diagrams with curve points,

FIG. 13-27 show examples of load-distance diagrams with different elliptical Fourier descriptors,

FIG. 28 shows an example of a bit mask for filtering load-distance diagrams,

FIG. 29 shows a schematic illustration of a neuron,

FIG. 30 shows a schematic illustration of a Kohonen network.

### DETAILED DESCRIPTION OF INVENTION

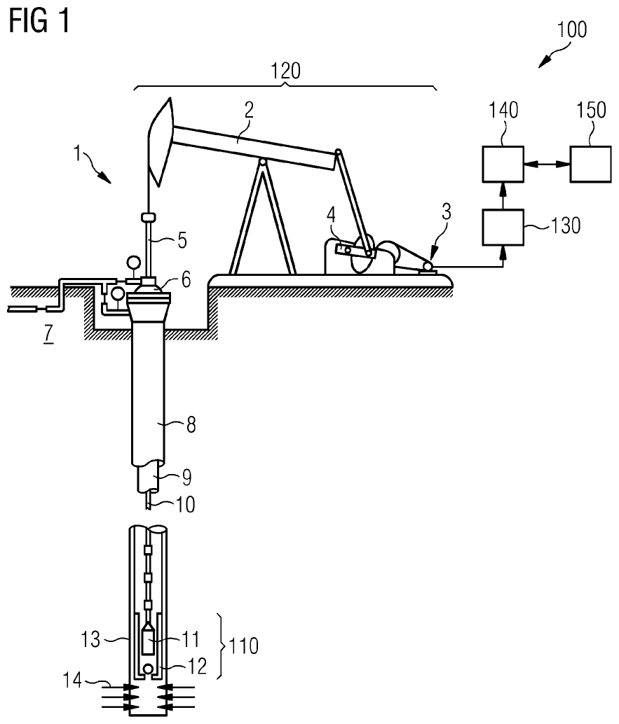

FIG. 1 shows an exemplary embodiment of a pump system 100 according to the invention having a drill-rod borehole pump 1 of the sucker-rod pump type.

The pump system 100 comprises a pump head 110, which is connected via a drill rod 5, to a kinematic converter 120.

The drill rod 5, 10 forms a so-called “rod cord” and passes through a borehole head 6, which is connected to a flow line 7 for discharging a pumped medium 14.

The borehole head 6 is adjoined by a jacket 8 in which a tube 9 runs, which guides the drill rod 5 or 10 respectively.

The pump head 110, which contains a piston 11 in a passage 12, is attached to the lower end of the drill rod 10. A movement of the piston 11 causes the conveying medium 14 to be pumped away.

The jacket 8 is formed in a drill hole 13.

The kinematic converter 120 is driven, for example, by a drive engine in the form of an electric motor 3 via a reduction gear 4. The kinematic converter 120 can also comprise a hydraulic power amplifier.

In this example, the mechanical connection of the kinematic converter 120 is formed via a crank arm 2, but can vary depending on the pump type used.

Such kinematic converters are familiar to the person skilled in the art, as is their description in the form of “properties of a kinematic converter” by means of the transformation function of mechanical motions and forces.

The kinematic converter 120 converts a rotational motion of the motor 3 into a linear motion of the drill rod 5, 10.

The properties of the kinematic converter 120 can be described, for example, by means of lever effects and translation ratios, as well as via the electrical drive power and moving masses. It should be noted that the position of a centrifugal mass along a rotational movement and the corresponding force acting on the drill rod 10 are in a temporal relationship, which is referred to as the reference phase angle. For a particular pump arrangement, a reference phase angle can be determined using the kinematic principles of mechanics, as is known to the person skilled in the art.

Furthermore, an acquisition means 130 is provided, which is configured to detect the current consumption and the operational voltage of the individual phases of the motor 3 during its operation. This can be carried out, for example, by means of an ammeter or voltmeter, which in particular acquires discrete measurement points with current or voltage values with high temporal resolution.

The current and operational voltage values acquired can be used to determine the effective power consumption and the apparent power consumption.

Furthermore, an analysis or computing device 140 with a memory 150 is provided, which is configured to carry out the method according to the invention using the acquisition means 130.

A person skilled in the art knows how a reference phase angle for the kinematic converter 120 can be determined using the properties of the kinematic converter 120 and the power consumption 72 of the motor 3, which angle describes the relationship between the maximum 83 of the power consumption 72 and the maximum of the force acting on the drill rod of the borehole pump 1.

It is also known to the person skilled in the art how a torque curve can be determined from the power consumption 72 of the motor 3 using the properties of the kinematic converter 120.

The acquisition means 130 is configured to acquire an operational load-distance diagram of the pump 1 with curve points and to provide it to the computing or analysis device 140 with the memory 150.

The analysis device 140 is configured to analyze the provided operational load-distance diagram using the method according to the invention, and to determine the operational property therefrom.

The method according to the invention can be implemented as a computer program comprising commands which, when executed by a computer 140, cause said computer to carry out the method according to the invention.

Furthermore, the method according to the invention can be provided as an electronically readable data carrier with readable control information stored thereon, which comprises at least the computer program according to the invention and is designed in such a way that it carries out the method according to the invention when the data carrier is used in a computing device 140.

The method according to the invention can also be provided as a data carrier signal, which transmits the computer program according to the invention.

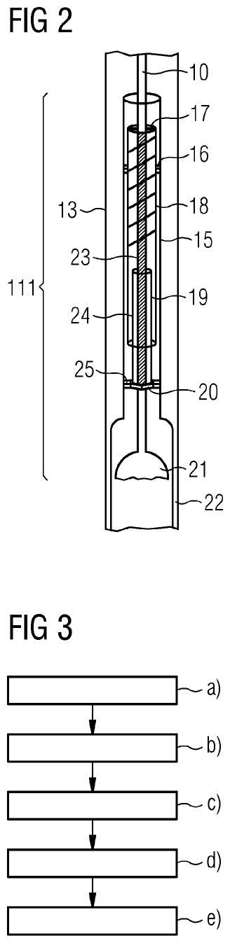

FIG. 2 shows another, more detailed example of a pump head 111 according to the prior art.

The rod cord or the drill rod 10 is driven according to FIG. 1 and is set into an up and down linear motion.

In the variant of the pump head 111 shown, a cover tube 15 with vertical grooves is arranged in the drill hole 13, which guides a rotating tube 18 with spiral grooves within the cover tube 15 via a holding device 16 and a self-aligning bearing 17.

A receiving tube 19 is connected via a wing nut 20 to a piston arrangement 21, which is located in a pump lining 22.

A calibrated rod 23 is connected to the drill rod 10 via a pin 24 and a holding device 25, which drives the piston arrangement by means of the linear movement.

FIG. 3 shows an exemplary embodiment of a flow diagram of a method for determining a load-distance diagram from the power consumption of an electrically operated pump motor, the method having the following steps:

a) detecting the current consumption and the operating voltage of the motor 3 with a sampling frequency over at least one pump cycle, which can be assigned to each of four operating phases of the borehole pump 1, in the form of discrete measurement points with current values, and determining from this the power consumption 72 of the motor 3 with power values,
b) for a pumping cycle, determining a period 85 and a maximum 82 of the power consumption 72, which corresponds to the torque maximum of the borehole pump 1,
c) determining a reference phase angle for the kinematic converter 120 using the properties of the kinematic converter 120 and the power consumption of the motor 3, which describes the relationship between the maximum 82 of the power consumption and the maximum of the force acting on the drill rod of the borehole pump 1,
d) determining a torque curve from the power consumption of the motor 3 using the properties of the kinematic converter 120,
e) determining the operational properties of the feed pump 1 from the torque curve determined in step d) using the period determined in step b) and the reference phase angle determined in step c).

The power values can be determined by forming the product of the discrete current values and the operating voltage.

For example, the period 85 can be determined from the power values of the measurement points using an approximated polynomial 80.

The period 85 can also be determined, for example, by means of a polynomial 80 which takes account of statistical mean values of the power values of the respective measurement points over at least five, preferably at least ten, particularly preferably at least fifty pump cycles for interpolation points of the polynomial.

For the measurement points, a reference value 81 can be determined, at which a maximum occurs for the change of the respective power value between two immediately consecutive measurement points, and the period 85 is determined using the reference value 81.

The operational properties of the feed pump 1 can be determined using a load-distance diagram 30, 50, 54, 57, 60-65, which is ascertained from the torque curve determined in step d) using the period determined in step b) and the reference phase angle determined in step c).

The reference phase angle can be determined with respect to the absolute maximum of the power values of the measurement points within a pump cycle.

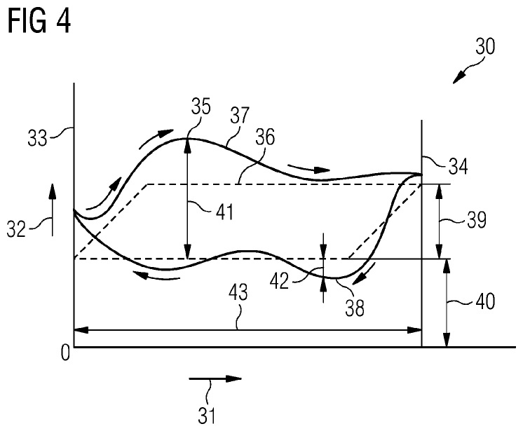

FIGS. 4 to 6 show examples of load-distance diagrams which are often used to determine the operational properties of drill-rod borehole pumps.

FIG. 4 shows a load-distance diagram 30.

On the x-axis, the position 31 of the polished rod is plotted, and on the y-axis the load 32 of the polished rod is plotted.

A lowest point of the pump stroke 33 and a highest point of the pump stroke 34 can be seen.

A tip of the polished rod 35 (PPRI) is also shown.

A chart 36 of the polished rod for a pump speed equal to zero is drawn in dashed lines.

Also shown is a chart 37 of the polished rod for a pump speed greater than zero.

A minimum load of the polished rod 38 (MPRL) is shown.

A gross piston load of 39 can also be read off.

In addition, a weight of the rods in the fluid 40 can be determined, as well as forces 41 and 42, and a pump stroke or pump displacement 43.

In FIG. 5 load-distance diagrams 50 with rod load at the setpoint value are shown as a function of the load 32 of the polished rod over the respective position 31 of the polished rod.

A load-distance diagram 51 shows the operation at full pump performance.

A load-distance diagram 52 shows the operation with the pumped conveying medium fully pumped out.

A respective setpoint value 53 can be seen.

In addition, load-distance diagrams 54 with rod load for a change of operation are shown as a function of the load 32 of the polished rod over the respective position 31 of the polished rod, with angles 55, 56 each being shown.

Furthermore, load-distance diagrams 57 with rod load with the respective mechanical work of the rods are shown.

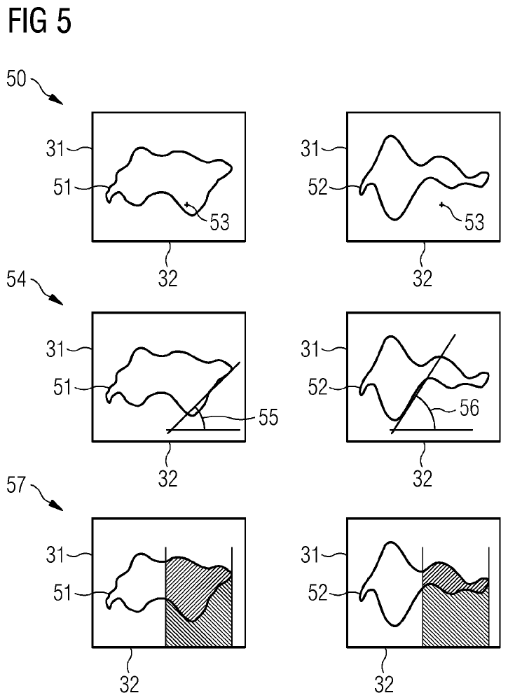

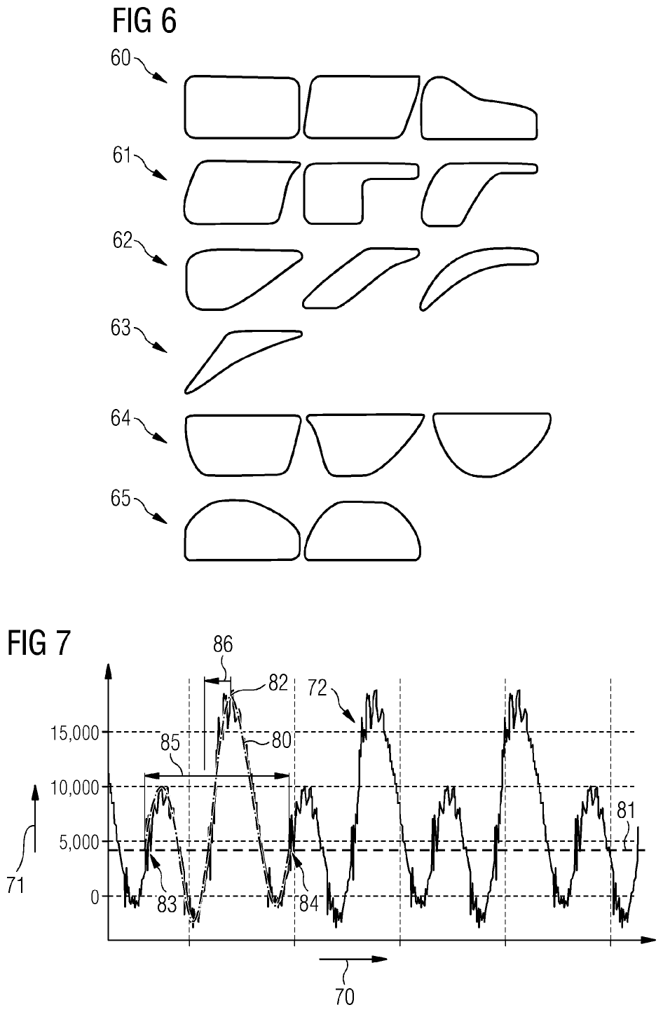

FIG. 6 shows load-distance diagrams 60-65 for various operational states.

Diagram 60 shows load-distance diagrams for a normal operation.

Diagram 61 shows load-distance diagrams for a fluid bearing.

Diagram 62 shows load-distance diagrams for gas exposure in the underground repository.

Diagram 63 shows a load-distance diagram for a stuck piston.

Diagram 64 shows the load-distance diagram in the event of a leak through a stationary valve.

A diagram 65 shows a load-distance diagram in the event of a leak through a moving valve.

The analysis device 140 can determine the operational property of the pump 1 from such load-distance diagrams.

For this purpose, it is provided that in a training mode, at least one model load-distance diagram with respective model-curve points is provided to the analysis device 140.

The model load-distance diagram is then normalized to a predefined reference variable by adjusting and unifying the value ranges.

At least two subsets of the model curve points are then acquired using machine learning as a first and at least one second feature.

A feature can be, for example, a specific curve shape or the location of curve points in the load-distance diagram, distances, or distance changes between individual curve points in the load-distance diagram.

By applying machine learning and models generated therefrom, which are formed from a set of individual load-distance diagrams, the statistical relevance of such features can attain a particularly high significance.

The first and the at least one second feature is used to generate and train at least one random forest model using a Kmeans algorithm.

The analysis device 140 normalizes the operational curve points to the reference variable in an operating mode.

Then, the analysis device 140 checks whether a similarity exists between at least a subset of the operational curve points and the at least one random forest model.

If this is the case, the operational property of the pump 1 is determined from this.

Optionally, at least two random forest models can be formed which have a low correlation with each other.

These at least two random forest models with weak correlation can be generated by randomly selecting one point from the set of operational curve points and replacing it from the set of operational curve points.

Alternatively, the at least two weakly correlated random forest models can be generated by further considering a subset when splitting a node in a random forest model.

As a further improvement, a sequence of the first and the at least one second feature within a pump cycle in the operation of the pump 1 in the respective random forest model can be taken into account in determining the operational property of the pump 1.

FIG. 7 shows an example of a temporal plot of a power curve of an electric drive motor for a drill-rod borehole pump, which was determined from the current consumption and operating voltage of the motor 3.

The diagram shows a time axis 70 and an axis 71 for the amplitudes of the current or power consumption.

A power consumption 72 is shown for which a zero point or zero axis 80 as well as a polynomial for averaged power consumption 81 can be determined.

For polynomial 80, a maximum value of the averaged power consumption 82 as well as zero crossings of the averaged power consumption 83, 84 can be determined.

Furthermore, a period of 85 of the averaged power consumption can be determined for polynomial 80.

From this, a phase angle 86 of the averaged power consumption can be determined, which describes the relationship between the rotation of the motor 3 and the drill rod 10 of the pump 1.

A corresponding load-distance diagram can be determined from the determined values, from which the operational properties of the drill-rod borehole pump 1 can be derived in a simple manner.

It can be seen that the absolute value of the period 85 does not need to be taken into account in the further calculation of the load-distance diagram.

In other words, in order to determine the power consumption it is not necessary to take the drive frequency of the pump motor into account.

The desired operational properties of the drill-rod borehole pump 1 can be determined by one or more corresponding load-distance diagrams in the sense of “setpoint values”, which are generated and trained in a training mode as a machine-learning based model. Load-distance diagrams of other pumps can also be included in this process.

For example, a question regarding the gas content in an oil-water-gas mixture of an extraction site can be answered by generating and training a training model for a known mixture.

Different training models can be generated for different questions regarding the condition of the pump and its components, as well as the composition of the pumped mixture.

This training model is used as a reference to an operational load-distance diagram.

Deviations in the operational load-distance diagram from the training model can be detected as an undesirable operational property.

In a training mode, a load-distance diagram model with model curve points based on machine learning is generated and trained by the analysis device 140.

Optionally, a reference point check can be carried out using the following steps: in the load-distance diagram model, at least two predefined analysis regions, which at least partially comprise the model curve points, can then be determined.

From the model curve points, for at least one region of the analysis regions a reference point can then be determined, which corresponds, for example, to the geometric center of gravity of the curve points of the respective region or to the area formed by the curve points and the region boundaries, for example, the diagram axes.

In an operating mode, for the operational load-distance diagram the analysis device 140 can check whether the at least one reference point determined in the training mode is included within the area enclosed by the operational curve points.

If this is the case, the operational property of the feed pump 1 can be determined from the reference point identified as “included”.

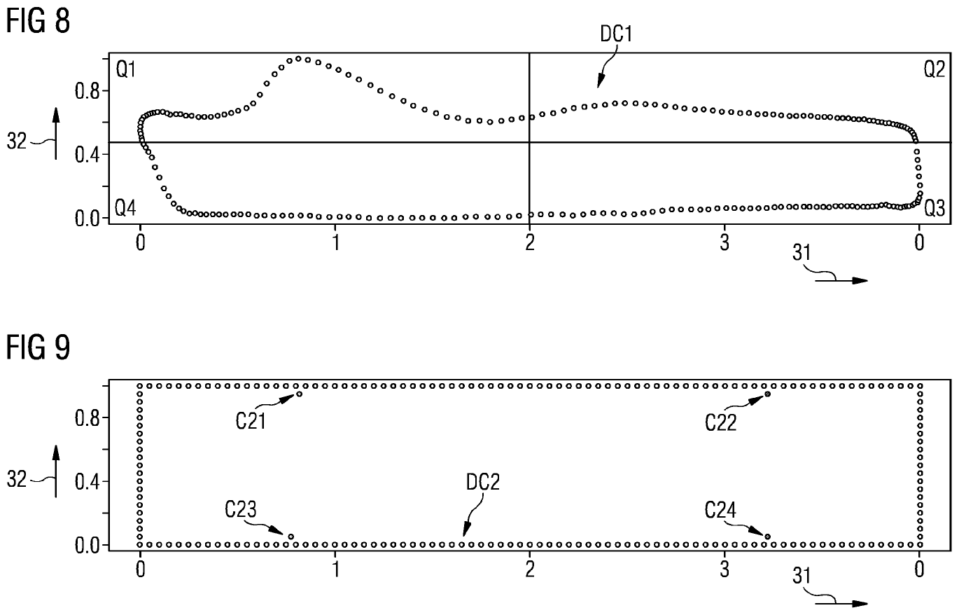

FIG. 8 shows an example of an operational load-distance diagram DC1 with curve points.

Four regions Q1-Q2 are shown, in the form of quadrants separated by a value 2 for the distance 31 and a value 0.5 for the load 32.

For example, the regions can be directly adjacent to each other so that no regions with curve points included in them are created without assignment to reference points.

If desired, however, regions can also be excluded, for example, to prevent regions with frequently error-prone curve points from being specifically excluded, in order to achieve an improvement in stability in determining the operational property of the pump.

For example, region boundaries can also overlap, so that a curve point can be assigned to multiple regions.

The measurement curve points and the model curve points between two adjacent points on the respective curves can each have distances which on average are at least 50%, preferably at least 80% and particularly preferably at least 95%, of the largest distance between two adjacent points of the respective curve.

This can result in approximately equal distances between measurement curve points.

FIG. 9 shows an example of an operational load-distance diagram DC2 with curve points.

For four regions, analogous to the preceding figure, a centroid point C21-C24 is drawn which corresponds to the geometric center of gravity of the curve points of the respective region or the area formed by the curve points and the region boundaries, for example the diagram axes.

It may be advantageous if the regions at least partially mutually overlap to better define a reference point of the region, for example, if there are too few curve points in a region.

In addition, at least one region can be defined, for example, for which no included curve point will be taken into account in the subsequent check.

In other words, a region can be excluded from closer examination.

This can be advantageous, for example, if a region is known to be particularly susceptible to error and/or is only of little or no relevance to certain conclusions about the operational properties.

When applying the method according to the invention, it may also be provided, for example, to carry out a plurality of independent tests of operational properties either sequentially or in parallel.

It is advantageous if, after a similarity check using one or more Kmeans decision trees, an additional centroid test is carried out according to the preceding statements.

Centroid-based post-processing enables operational properties to be detected in a particularly targeted manner and the detection rate for determining the operational property to be further improved.

Of course, an iterative check may also be provided by applying the method according to the invention in order to incrementally substantiate specific suspected moments with regard to a potential operational property, by adjusting the criteria with regard to the training model.

For example, the accuracy requirements can be successively increased by increasing reference points in the respective subsequent training model, or else alternative reference points can be investigated in order to draw further conclusions for the operational property under investigation, for example, by means of a combination of two different training models.

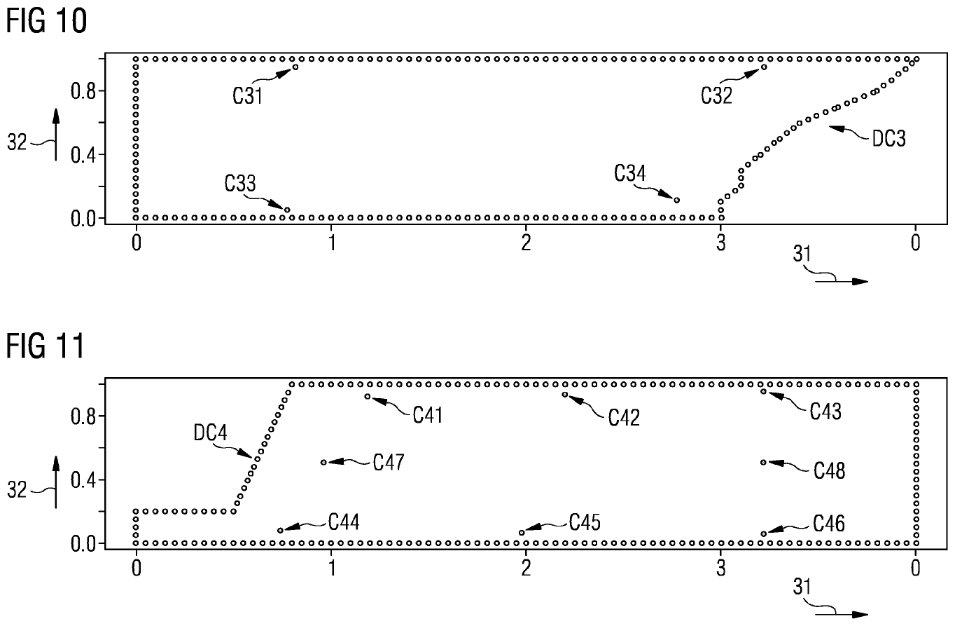

FIG. 10 shows an example of an operational load-distance diagram DC3 with curve points.

For each of four regions, analogous to the preceding figure, a centroid point C31-C34 is drawn which corresponds to the geometric center of gravity of the curve points of the respective region.

FIG. 11 shows an example of an operational load-distance diagram DC4 with curve points.

In this example, eight regions are shown, which are separated by a value 2 for the distance 31 and a value greater than or less than 0.5 for the load 32, wherein two further regions are provided for the value 0.5 on the load axis 32.

For each of the eight regions, a centroid point C41-C48 is drawn which corresponds to the geometric center of gravity of the curve points of the respective region.

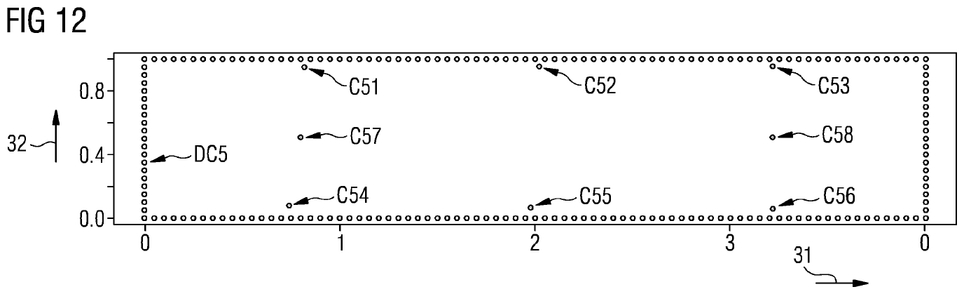

FIG. 12 shows an example of an operational load-distance diagram DC5 with curve points.

For each of eight regions, analogous to the preceding figure, a centroid point C51-C58 is drawn which corresponds to the geometric center of gravity of the curve points of the respective region.

FIGS. 13 to 27 show examples of load-distance diagrams with different elliptical Fourier descriptors, each representing harmonics of a total of 15 Fourier coefficient pairs aᵢ,bᵢ,cᵢ and dᵢ.

Each of the dashed curves represents a recorded load-distance diagram to be analyzed and detected, i.e. classified, by means of the method according to the invention.

The dashed curves in the first quadrant are shown for improved clarity only; an analysis refers to a normalized plot.

The solid curves represent a corresponding harmonic of a load-distance curve to be examined.

An nth harmonic is a curve or polynomial of nth order.

In the figures, the ratio between distance and load is normalized to 4:1 as an example.

In principle, a minimum-maximum scaling is a simple option for the normalization.

This allows the values for load and distance to be mapped to an interval for the distance between zero and four, and an interval for the load between zero and one.

In principle, other normalizations are equally suitable as long as they allow different load-distance diagrams to be compared.

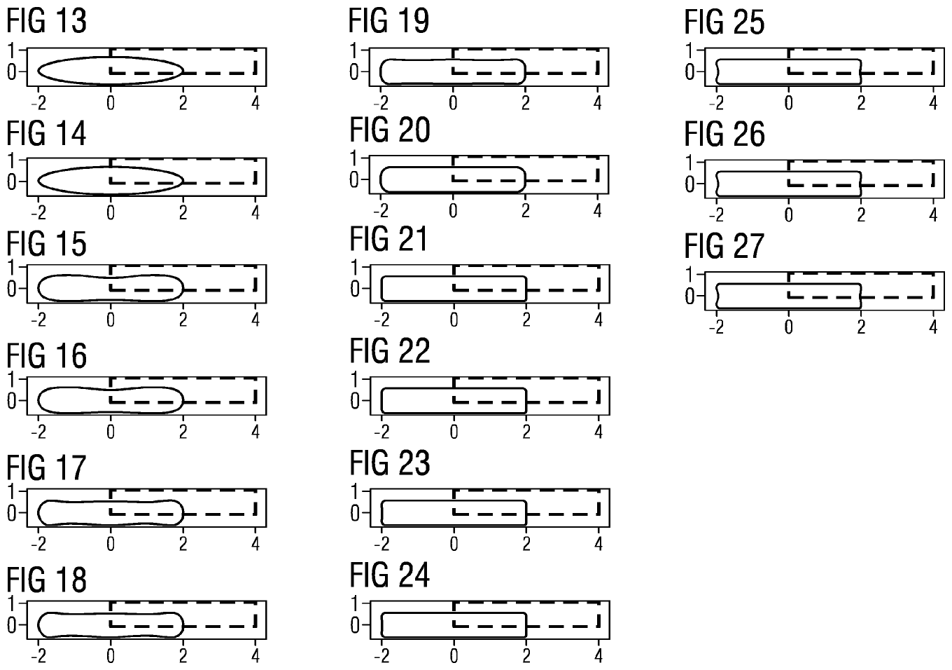

FIG. 13 shows an example for the first harmonic, FIG. 14 for the second harmonic, etc. and FIG. 27 for the 15th harmonic of the Fourier coefficient pairs aᵢ,bᵢ,cᵢ and dᵢ.

Of course, other numbers of harmonics may also be suitable for performing a sufficiently accurate classification.

It is clear that by iteratively adding a further harmonic, i.e. extending the order of the curve, the detection of the desired dashed curve is improved with increasing order and the classification becomes more accurate and reliable.

Subsequently, the operational property of the pump can be determined very precisely.

The examples show Fourier transformations with curves of the operational load-distance diagram with iteratively increasing order.

An extension of a Fourier series for an x-projection of a curve of a load-distance diagram can be described by the following relation:

$$x ( t ) = {\sum }_{n = 1}^{N} [ {a}_{n} cos ( \frac{2 π nt}{T} ) + {b}_{n} sin ( \frac{2 π nt}{T} ) ]$$

with
T the period, i.e. the sum of all T increments,
n the number of harmonics considered,
N the total number of all harmonics,
aₙ, bₙ the elliptical Fourier coefficients of the nth harmonic.

The Fourier coefficients for the x-projection of the curve, i.e. the distance, can be determined by the following relation:

$${a}_{n} = \frac{T}{2 {π}^{2} {n}^{2}} {\sum }_{p = 1}^{K} \frac{Δ {x}_{p}}{Δ {t}_{p}} [ cos ( \frac{2 π {nt}_{p}}{T} ) - cos ( \frac{2 π {nt}_{p - 1}}{T} ) ] \\ {b}_{n} = \frac{T}{2 {π}^{2} {n}^{2}} {\sum }_{p = 1}^{K} \frac{Δ {x}_{p}}{Δ {t}_{p}} [ sin ( \frac{2 π {nt}_{p}}{T} ) - sin ( \frac{2 π {nt}_{p - 1}}{T} ) ]$$

with
T the period,
n the number of harmonics considered,
K the total number of all connections,
aₙ, bₙ the elliptical Fourier coefficients of the nth harmonic,
xₚ the sum of all connections on the x-axis, ps p the index in a connection chain,
tₚ the length of a chain along a path.

The Fourier coefficients for the y-projection of the curve, i.e. the load, can be determined in a similar manner:

$${c}_{n} = \frac{T}{2 {π}^{2} {n}^{2}} {\sum }_{p = 1}^{K} \frac{Δ {y}_{p}}{Δ {t}_{p}} [ cos ( \frac{2 π {nt}_{p}}{T} ) - cos ( \frac{2 π {nt}_{p - 1}}{T} ) ] \\ {d}_{n} = \frac{T}{2 {π}^{2} {n}^{2}} {\sum }_{p = 1}^{K} \frac{Δ {y}_{p}}{Δ {t}_{p}} [ sin ( \frac{2 π {nt}_{p}}{T} ) - sin ( \frac{2 π {nt}_{p - 1}}{T} ) ]$$

with
T the period,
n the number of harmonics considered,
K the total number of all connections,
cₙ, dₙ the elliptical Fourier coefficients of the nth harmonic,
yₚ the sum of all connections on the y-axis,
p the index in a connection chain,
tₚ the length of a chain along a path.

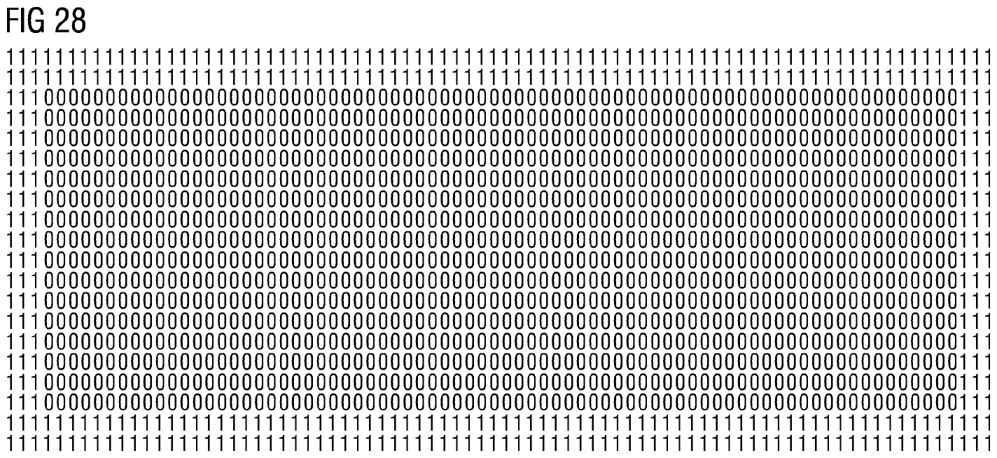

FIG. 28 shows an example of a bit mask for filtering load-distance diagrams, i.e. a variant for classifying curve shapes in load-distance diagrams.

By applying a binary filter mask, features of a load-distance diagram can be assigned to corresponding bit patterns of the mask.

In this example, a rectangular filter mask with a size of 80×20 bits is shown, with the pattern representing a “healthy” pump.

A bit vector b₁₁, . . . , b_{1N}, . . . , b_{M1}, . . . , b_{MN} is used as an input variable, where M is the dimension of the load in rows and N is the dimension of the displacement in columns.

However, the representation as a bit mask requires a rather large number of points, that is, bits for the mask, such as 80×20=1600 bits in this case.

For the application of such a bit mask, it is advantageous to implement a prior normalization.

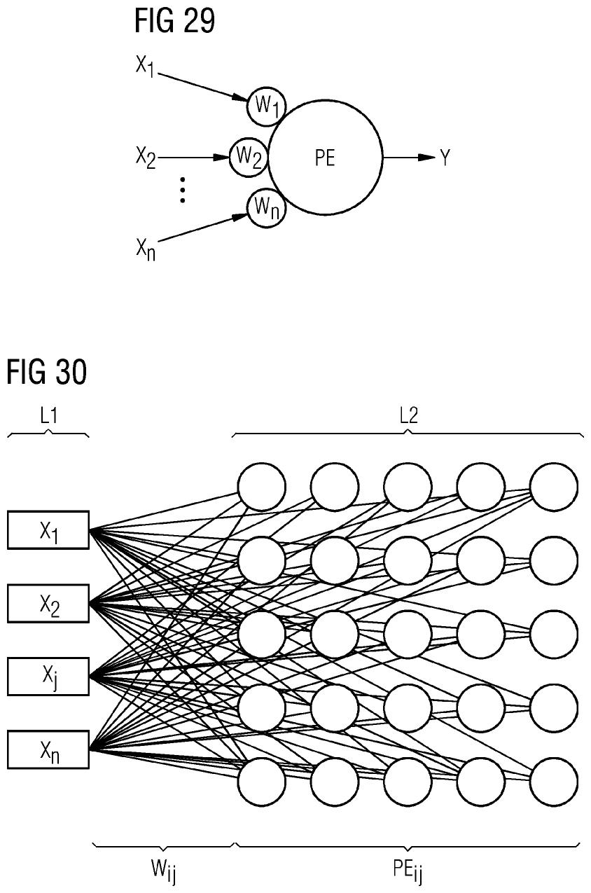

FIG. 29 shows a schematic representation of a neuron as an element in systems with artificial intelligence.

Input variables Xⱼ, which form an input vector \vec{X}, are fed via weight functions Wⱼ, which form a weight vector \vec{W}, to a neuron, i.e. a processing element, which forms an output variable Y.

A “Kohonen Feature Mapping Neural Network” is formed from the neurons, which represents a machine learning-based model.

This model is generated and trained with training data, wherein the training data can also originate from other pump systems that are not identical in design.

Similarly to a multi-layer perceptron (MLP) network, a Kohonen network also has a large number of neurons PE (processing elements) with a plurality of inputs Xⱼ, weighted by means of respective weight functions Wⱼ, and an output Y.

Various functions, such as the Euclidean distance, Manhattan distance or Minkowsky distance, can be used to calculate the output variable Y.

However, the important difference between a Kohonen network and an MLP, for example, is the architecture, which comprises an input layer L1 with N inputs, followed by a further layer L2 with a plurality of neurons arranged in a two-dimensional grid.

The grid has a length L and a height H, wherein one neuron is arranged in each grid position.

Each input Xⱼ is connected to all neurons PEᵢⱼ of the second layer by means of a weight function Wⱼ.

FIG. 30 shows a schematic illustration of a Kohonen network.

Input variables X₁,X₂,Xⱼ to X_{N} are fed via respective weight functions Wᵢⱼ to a respective neuron PEᵢⱼ, which forms an output variable.

It can be seen that each input variable is fed to each neuron.

For each neuron, an output variable is determined which represents, for example, a detected operational property of the pump.

The neural Kohonen network is trained by modifying the weight functions Wᵢⱼ and other variable rules.

The goal of a single learning step is to find the neuron PEᵢⱼ, the weight vector \vec{W} of which is located as close as possible to the input vector \vec{X}, i.e. corresponds to the best match to the input vector \vec{X}.

This can be achieved, for example, by determining the Euclidean distance for all neurons PEᵢⱼ and the input vector \vec{X}, wherein the neuron PE with the shortest distance is identified as the winner.

The neuron with the best match is labeled with the class number associated with the input vector \vec{X}.

If this neuron already has an associated label, the label is updated with the latest class number.

The weight vector \vec{W} of the neuron and its neighboring neuron is then updated without changing the remaining weight vectors of the other neurons.

This updating is understood to mean a modified weight value for the respective neurons, wherein different permutations of weight values are performed on neighboring neurons in order to find an optimal match.

Methods for efficient iteration of weight values of input vectors of neurons are known to the person skilled in the art.

Neighboring neurons are located adjacent to each other in the grid, i.e. there are eight neighbors.

As a result, the neighboring neurons approximate the input vector more closely, while the topology of the input space, i.e. the sequence of the input variables, is retained.

Therefore, the Kohonen network can also be compared with the human visual cortex, in which visible information is processed very efficiently.

This is the main advantage that distinguishes the application of a Kohonen network for the classification of curves in load-distance diagrams.

It is therefore particularly advantageous if elliptical Fourier descriptors, i.e. Fourier coefficient pairs a₁,b₁,c₁,d₁, . . . , a_{N},bₙ,c_{N},d_{N}, which represent the curve shape of a load-distance diagram, are used as input variables X₁,X₂,Xⱼ to X_{N} of the neural network in order to classify load-distance diagrams.

If new load-distance diagrams are used which are evenly distributed over the classes to be learned, it is possible to create a machine learning model (ML) which correctly classifies 75% or more of the test data, which differs from training data.

In comparison to the application of a bit mask according to FIG. 28, the use of a Kohonen network with elliptical Fourier descriptors is much more advantageous than a Kohonen network that is generated by means of a bit mask, because due to the size of the bit mask, a significantly larger Kohonen network is formed.

This greatly increases the learning time without achieving better test results compared to Kohonen networks with elliptical Fourier descriptors as input variables.

### LIST OF REFERENCE SIGNS

1 drill-rod borehole pump
2 beam, crank arm
3 drive engine, motor
4 reduction gear
5 polished rod
6 borehole head
7 flow line
8 coat
9 tube
10 rod cord
11 piston
12 passage
13 borehole
14 conveying medium
15 cover tube with vertical grooves
16, 25 holding device
17 self-aligning bearing
18 rotating tube with spiral grooves
19 receiving tube
20 wing nut
21 piston arrangement
22 pump lining
23 calibrated rod
24 pin
30 load-distance diagram
31 position of the polished rod
32 load on the polished rod
33 lowest point of the pump stroke
34 highest point of the pump stroke
35 tip of the polished rod, PPRI
36 chart of polished rod for pumping speed equal to zero
37 chart of polished rod for pumping speed greater than zero
38 minimum load on polished rod, MPRL
39 gross piston load
40 weight of rods in fluid
41, 42 force
43 distance
50 load-distance diagram with rod load at setpoint
51 pump, full power
52 pumped empty
53 setpoint
54 load-distance diagram with rod load during operation change
55, 56 angle
57 load-distance diagram with mechanical operation of the rods
60 load-distance diagram in normal operation
61 load-distance diagram for a fluid bearing
62 load-distance diagram for gas action
63 load-distance diagram with stuck piston
64 load-distance diagram with leak through a stationary valve
65 load-distance diagram with leak through a moving valve
70 time axis
71 axis for amplitude of current or power consumption
72 power consumption
80 selected zero point or zero axis
81 polynomial for averaged power consumption
82 maximum of the averaged power consumption
83, 84 zero crossing of the averaged power consumption
85 period of the averaged power consumption
86 determined phase angle of the averaged power consumption
100 pump system
110, 111 pump head
120 kinematics converter
130 acquisition means, acquisition device
140 computing device, analysis device
150 memory
C21-C24, C31-C36, C41-C48, C51-C58 geometric center of gravity, centroid
DC1-DC5 load-distance diagram, Dynacard
L1, L2 layer in the neural network
PE, PEᵢⱼ neuron, or processing element
Q1-Q4 region, quadrant
W₁, W₂, Wₙ, Wⱼ, Wᵢⱼ weight function
X₁, X₂, X_{N}, Xⱼ input variable
Y output variable

1. A computer-implemented method for determining an operational property of a drill-rod borehole pump, wherein the pump has a pump head which is connected to a kinematic converter via a drill rod, and the kinematic converter is driven by a motor during operation and a load-distance diagram with curve points for the pump is ascertained by an analysis device using an acquisition device and is provided as an operational load-distance diagram with operational curve points, the method comprising:
in a training mode, providing at least one model load-distance diagram with respective model curve points by the analysis device, said model load-distance diagram being normalized to a predefined reference variable, and for at least one subset of the model curve points generating and training a model on the basis of a Kohonen network with elliptical Fourier descriptors, and
in an operating mode, normalizing the operational curve points to the reference variable, determining elliptical Fourier descriptors for the operational curve points, and checking to determine whether a similarity exists between the elliptical Fourier descriptors of the operational curve points and the model of the Kohonen network, and if so, determining the operational property of the pump therefrom, wherein the motor is electrically operated and the acquisition device is configured to detect electrical power consumption of the motor during its operation, from which the operational properties of the pump are determined.

2. The method as claimed in claim 1,
wherein the Kohonen network has an input layer with input variables and a second layer with neurons, and each input variable is connected to all of the neurons of the second layer via a respective weight function.

3. The method as claimed in claim 2,
wherein the neurons in the second layer are arranged as a virtual two-dimensional grid.

4. The method as claimed in claim 2,
wherein during the training of the Kohonen network, a neuron with an input vector applied to the input variables is trained first, and then neighbors of the neuron are determined, and the corresponding weight functions for the neighbors are adjusted and the model is trained again.

5. (canceled)

6. A computer program stored on a non-transitory computer readable medium, comprising:
commands stored thereon which, during their execution by a computer, cause the computer to carry out the method as claimed in claim 1.

7. A non-transitory electronically readable data carrier, comprising:
readable control information stored thereon, which comprises at least one computer program configured in such a way that it carries out a method as claimed in claim 1 when the data carrier is used in a computing device.

8. A non-transitory data carrier comprising:
the computer program as claimed in claim 6.

9. An analytical device comprising:
a memory for determining an operational property of a drill-rod borehole pump,
wherein said analytical device is configured to analyze a supplied operational load-distance diagram with the method as claimed in claim 1, and to determine the operational property therefrom.

10. A pump system for determining an operational property of a drill-rod borehole pump, wherein the pump has a pump head which is connected to a kinematic converter via a drill rod, and the kinematic converter is driven by a motor during operation, the pump system comprising:
an acquisition device which is configured to acquire and provide a load-distance diagram of the pump with curve points, and
an analysis device with a memory as claimed in claim 9, which is configured to determine the operational property from the provided operational load-distance diagram.
